(19) United States
(12) Patent Application Publication
(10) Pub. No.: US 2022/0222594 A1
(43) Pub. Date: Jul. 14, 2022

(54) FACILITATING ANALYSIS OF ATTRIBUTION MODELS

(71) Applicant: ADOBE INC., San Jose, CA (US)

(72) Inventors: James William SNYDER, JR., Sunnyvale, CA (US); Sai Kumar ARAVA, Santa Clara, CA (US); Yiwen SUN, Sunnyvale, CA (US); Zhenyu YAN, Cupertino, CA (US)

(21) Appl. No.: 17/146,655

(22) Filed: Jan. 12, 2021

(51) Int. Cl. G06Q 10/06

(52) U.S. Cl. CPC G06Q 10/067; G06Q 30/0201; G06Q 10/06315

(57) ABSTRACT

Methods and systems are provided for facilitating analysis of attribution models. In embodiments described herein, an indication to compare a set of attribution models is received. For each attribution model, a lift score is determined that indicates an extent of improvement as compared to a baseline attribution model. The lift score can be generated based at least on a divergence between a weighted-positive path distribution and a negative path distribution determined using a sign correction term and/or on a divergence between a weighted-positive path distribution and a reference distribution, which reflects the deviation between positive and negative paths. The weighted-positive path distribution reflects attribution scores, generated via the corresponding attribution model, applied as weights to a positive event paths and used to produce a distribution. Thereafter, the lift scores associated with the corresponding attribution models can be used to provide an indication of a most effective attribution model, or relative performance, of the set of attribution models.

### BACKGROUND

Generally, attribution models are used to attribute credit to various events for an outcome (e.g., a conversion). Example attribution models may include, for instance, first touch, last touch, linear, etc. In many cases, a user may have a number of attribution models to choose from to determine credit. For example, in some cases, a user may be able to select a particular attribution model, from among a set of attribution models, to use to attribute credit. As can be appreciated, such varied attribution models often produce very different results. Although having multiple options for attribution models may be advantageous, it can be difficult to determine a best model, or most effective model, for a particular data set or a target success metrics.

Various approaches have been used in an attempt to determine a best modeling approach based on some target success metric. Such approaches, however, require either a type of experiment, such as AB tests, or a simulation. Utilizing an experiment or simulation to identify a “best” attribution model, however, is time consuming and expensive. It may oftentimes be inaccurate if setup incorrectly as well.

### SUMMARY

Accordingly, embodiments of the present disclosure are directed to to facilitating analysis of attribution models. In particular, the technology described herein provides an efficient model quality measurement tool without the need for experiments or simulations. The model analysis tool described herein identifies how effectively different attribution models assign credit to events (e.g., touchpoints) that frequently appear on positive event paths (e.g., conversion paths) and infrequently appear on negative event paths (e.g., non-conversion paths). To do so, various attribution models can be compared to a baseline model via corresponding divergences to provide a relative performance of the attribution models as compared to the baseline model. Advantageously, such a model analysis tool enables efficient and robust comparison of model quality for both rule-based models and algorithmic models, without requiring expensive and time consuming experiments and simulations. The model analysis tool can be used to identify or indicate a most effective attribution model, which can then be manually (by a user) or automatically selected for use in another application, such as budget optimization. Additionally or alternatively, the model analysis tool can be used to facilitate monitoring of quality of both deployed models and model code changes. Finally, the tool is scalable and dependent only on data available to any attribution model.

### BRIEF DESCRIPTION OF THE DRAWINGS

FIG. 1 depicts a diagram of an environment in which one or more embodiments of the present disclosure can be practiced, in accordance with various embodiments of the present disclosure;

FIG. 2 depicts an example configuration of an operating environment in which some implementations of the present disclosure can be employed, in accordance with various embodiments of the present disclosure;

FIG. 3 illustrates an example of scored attribution models, in accordance with embodiments of the present disclosure;

FIG. 4 provides an example representation of a positive probability distribution and a negative probability distribution, in accordance with embodiments of the present disclosure;

FIG. 5 provides an example representation of a positive probability distribution, a negative probability distribution, and a weighted-positive probability distribution, in accordance with embodiments of the present disclosure;

FIGS. 6A-6C provide examples of various divergences between two distributions and corresponding extent of dissimilarity, in accordance with embodiments of the present invention;

FIG. 7 provides an example of a model insights that may be provided via a graphical user interface, in accordance with embodiments of the present disclosure;

FIG. 8 is a process flow showing a method for facilitating analysis of attribution models, in accordance with embodiments of the present disclosure;

FIG. 9 is a process flow showing a method for facilitating analysis of attribution models, in accordance with embodiments of the present disclosure; and

FIG. 10 is a block diagram of an example computing device in which embodiments of the present disclosure may be employed.

### DETAILED DESCRIPTION

Various marketing analysis tools utilize attribution models to analyze data. Generally, an attribution model refers to a model that determines credit for an outcome. Attribution generally seeks to assign a proportion of credit attributed to a particular outcome, such as a conversion. Upon generating attributions via an attribution model, such attributions can be input to a marketing analysis tool (e.g., ROI analysis), budget optimization analysis, and the like.

Oftentimes, various attribution models may be potential models to use to determine credit for an outcome. For example, in some cases, a user may be able to select a particular attribution model, from among a set of attribution models, to use to identify credit for an outcome. Example attribution models may include, for instance, first touch, last touch, linear, etc. As can be appreciated, such varied attribution models often produce very different results. Although having multiple options for attribution models may be advantageous, it can be difficult to determine a best model, or most effective model, for a particular data set or a target success metric.

Accordingly, various approaches have been used to determine a best modeling approach based on some target success metric. Such approaches, however, require either a type of experiment, such as AB tests, or a simulation. One example approach uses a measure of model fit to identify model effectiveness. To this end, some attribution models provide measure of fit such as area under a receiver operating characteristic curve (AUC), precision/recall, or coefficient of determination (R²). Such error metrics can be used as a proxy to determine the effectiveness of the model. For rule-based approaches, however, it is not possible to obtain a similar measure of fit. As another example approach, AB testing includes implementing recommendations to marketing through budget allocation from an attribution model to the best extent possible for one certain group of users while another group of users are not exposed to these recommendations. Thereafter, the ROI lift of users exposed to these marketing efforts are compared with respect to the remaining group of users to determine the efficacy of the model. However, implementing the recommendations even for a small segment of population requires a high degree of trust in the model. Further, iteratively implementing this process to select a best model is expensive and time consuming for marketers. Instead of running an experiment, it is also possible to run a simulation to predict the impact of employing different marketing strategies based on a variety of attribution models. However, simulations themselves are based on (typically highly computationally expensive) models, which may be rules-based or use machine learning (e.g. recurrent neural networks). These can be extraordinarily difficult and time consuming to setup and rely on the user having confidence in the simulation model.

In addition to such experiments and simulations being very expensive and time consuming to setup properly, the results and corresponding conclusions drawn may not be valid if not set up properly. As a result, many marketing teams are not willing to undertake these tasks. As such, model selection is often performed based on biases of the individual marketing teams, which may result in a lower quality budget optimization outcome.

As such, embodiments disclosed herein are directed to facilitating analysis of attribution models. In particular, the technology described herein provides an efficient model quality measurement tool without the need for experiments or simulations. The model analysis tool described herein identifies how effectively different attribution models assign credit to events (e.g., touchpoints) that frequently appear on positive event paths (e.g., conversion paths) and infrequently appear on negative event paths (e.g., non-conversion paths). Advantageously, such a model analysis tool enables efficient and robust comparison of model quality for both rule-based models and algorithmic models, without requiring expensive and time consuming experiments and simulations. The model analysis tool can be used to identify or indicate a most effective attribution model, which can then be manually (by a user) or automatically selected for use in another application, such as budget optimization. Additionally or alternatively, the model analysis tool can be used to facilitate monitoring of quality of both deployed models and model code changes. Finally, the tool is scalable and dependent only on data available to any attribution model. In utilizing such a model analysis tool described herein, substantially fewer computation resources are used in comparison to conventional simulation and experimentation designs. In particular a decreased amount of resources are used as significantly less calculations are performed to produce a metric. As opposed to taking a short amount of time (e.g., minutes) to produce metrics, conventional simulation designs can take days or weeks with high computer utilization and experiments can take weeks to months to produce such metrics.

In operation, as described herein, an attribution model analysis may be initiated, for example, via a user (e.g., marketer) selection. The model analysis tool may then be used to generate lift scores for a set of attribution models being analyzed. The lift score can provide an indication of a percent improvement or effectiveness relative to a baseline model (which may be any one of the attribution models). To generate a lift score for a particular attribution model, at a high level, a set of data, including event paths and corresponding outputs, is accessed. Events within the event path are scored using the particular attribution model. Using the set of data and the scored events, various distributions are generated including a positive path distribution, a negative path distribution, a reference path distribution, and a weighted-positive path distribution. The positive path distribution is generally based on the number of positive event paths (e.g., resulting in a conversion) touched by each lagged event. The negative path distribution is generally based on the number of negative event paths (e.g., resulting in a non-conversion) touched by each lagged event. The reference path distribution generally reflects the difference between the positive and negative path distributions. The weighted-positive path distribution is generally based on scoring the positive path events, from the attribution model, and using the scores as weights when constructing the distribution.

The various distributions are used to determine various divergence measures. As described herein, a first divergence between the weighted-positive path distribution associated with the attribution model and the negative path distribution can be generated as well as a second divergence between the weighted-positive path distribution and the reference path distribution. As divergences associated with the attribution model are compared to divergences associated with a baseline model to determine a lift value for the attribution model, divergences associated with the baseline model can also be determined. For example, a divergence between a baseline weighted-positive path distribution, associated with the baseline model, and the negative path distribution can be determined as well as a divergence between the baseline weighted-positive path distribution and the reference path distribution.

Such divergences can then be used to generate a lift value for the attribution model. For example, a lift value for an attribution model may be determined using the first divergence relative to a divergence between a baseline weighted-positive path distribution associated with a baseline model and the negative path distribution and using a divergence between the baseline weighted-positive path distribution and the reference path distribution relative to the second divergence.

As can be appreciated, lift values associated with additional attribution models can be determined in a similar manner. The various lift values can then be used to indicate a most effective attribution model. In some cases, each of the lift values may be presented (via a graphical user interface) in accordance with the corresponding attribution model. In other cases, an attribution model with a greatest lift score may be presented or automatically selected for use in another application (e.g., to determine budget optimization).

Although embodiments are generally described herein for performing analysis of attribution models, such an analysis tool can be used for comparisons or analysis of other models and the disclosure herein is not limited to analysis of attribution models.

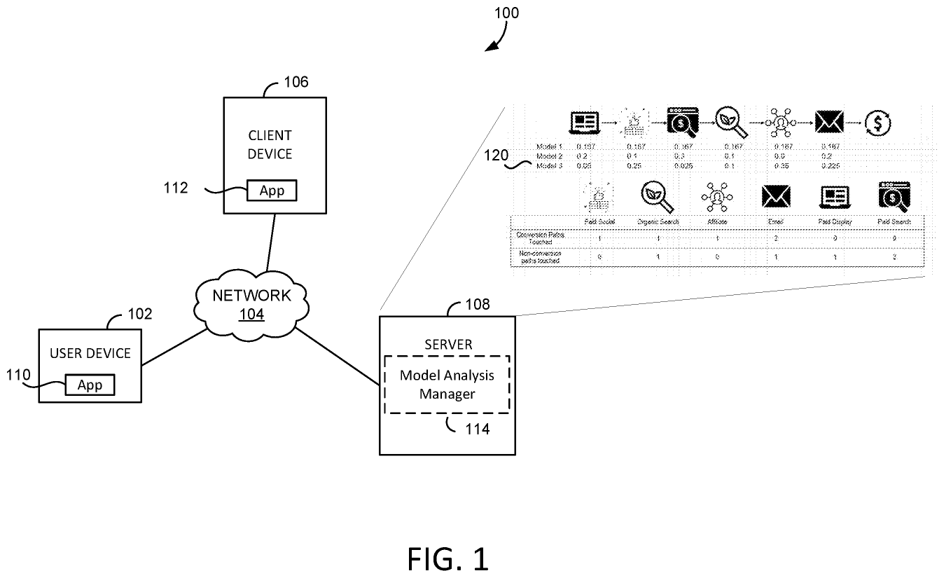

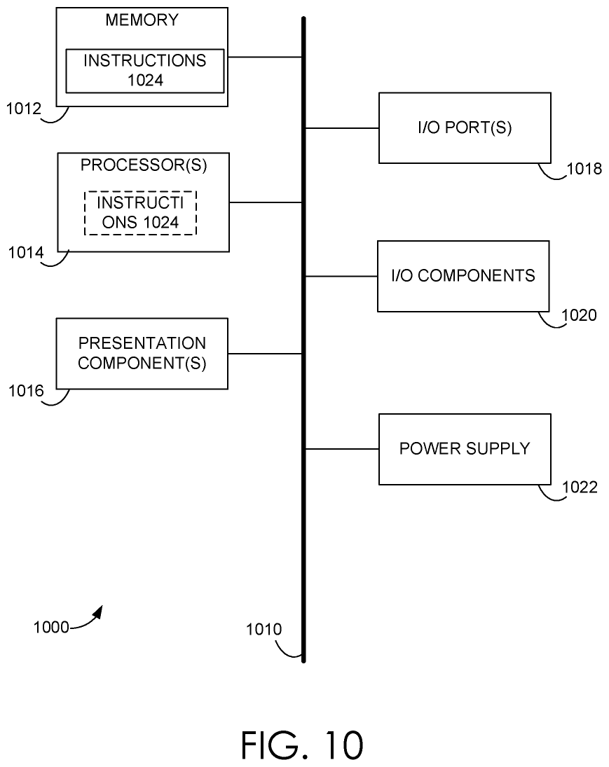

Turning to FIG. 1, FIG. 1 depicts an example configuration of an operating environment in which some implementations of the present disclosure can be employed. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether for the sake of clarity. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, some functions may be carried out by a processor executing instructions stored in memory as further described with reference to FIG. 10.

It should be understood that operating environment 100 shown in FIG. 1 is an example of one suitable operating environment. Among other components not shown, operating environment 100 includes user device(s) 102, network 104, client device(s) 106, and server(s) 108. Each of the components shown in FIG. 1 may be implemented via any type of computing device, such as one or more of computing device 1000 described in connection to FIG. 10, for example. These components may communicate with each other via network 104, which may be wired, wireless, or both. Network 104 can include multiple networks, or a network of networks, but is shown in simple form so as not to obscure aspects of the present disclosure. By way of example, network 104 can include one or more wide area networks (WANs), one or more local area networks (LANs), one or more public networks such as the Internet, and/or one or more private networks. Where network 104 includes a wireless telecommunications network, components such as a base station, a communications tower, or even access points (as well as other components) may provide wireless connectivity. Networking environments are commonplace in offices, enterprise-wide computer networks, intranets, and the Internet. Accordingly, network 104 is not described in significant detail.

It should be understood that any number of user devices, client devices, servers, and other components may be employed within operating environment 100 within the scope of the present disclosure. Each may comprise a single device or multiple devices cooperating in a distributed environment.

User device 102 and client device 106 can be any type of computing device capable of being operated by a user. For example, in some implementations, such devices are the type of computing device described in relation to FIG. 10. By way of example and not limitation, user devices and client devices may be embodied as a personal computer (PC), a laptop computer, a mobile device, a smartphone, a tablet computer, a smart watch, a wearable computer, a personal digital assistant (PDA), an MP3 player, a global positioning system (GPS) or device, a video player, a handheld communications device, a gaming device or system, an entertainment system, a vehicle computer system, an embedded system controller, a remote control, an appliance, a consumer electronic device, a workstation, any combination of these delineated devices, or any other suitable device.

The user device and client device can include one or more processors, and one or more computer-readable media. The computer-readable media may include computer-readable instructions executable by the one or more processors. The instructions may be embodied by one or more applications. The application(s) may generally be any application capable of facilitating analysis of attribution models. In some implementations, the application(s) comprises a web application, which can run in a web browser, and could be hosted at least partially server-side (e.g., via model analysis manager 114). In addition, or instead, the application(s) can comprise a dedicated application. In some cases, the application is integrated into the operating system (e.g., as a service). An application may be accessed via a mobile application, a web application, or the like.

User device and client device can be computing devices on a client-side of operating environment 100, while the server 108 can be on a server-side of operating environment 100. The model analysis manager 114 may comprise server-side software designed to work in conjunction with client-side software on user device and/or client device so as to implement any combination of the features and functionalities discussed in the present disclosure. This division of operating environment 100 is provided to illustrate one example of a suitable environment, and it is noted there is no requirement for each implementation that any combination of user device, client device, and/or model analysis manager to remain as separate entities.

The client device 106 may be any device with which a client interacts. As used herein, a client generally refers to an individual, such as a consumer, that is being monitored in association with events. In this way, a client can be an individual that performs, initiates, interacts, or engages with a website, application, etc. Clients do not need to be pre-identified, that is, an individual may become client by virtue of engaging in an initial event of a journey. A client may interact with the client device 106 via a graphical user interface associated with an application or website (e.g., a website or set of websites for which marketing analysis is being performed). Such interactions with the client device 106 may be monitored and tracked. In some cases, the client device 106 (e.g., via an application 112) may recognize or detect events. In other cases, another component (e.g., a server interacting with the client device) may monitor or detect such events occurring in association with a journey or event path. A journey or event path generally refers to a set of events (e.g., sequence of events), for example, related to marketing. An event path or journey may include any number of events, segments or portions.

In accordance with embodiments herein, the user device 102 can facilitate analysis of attribution models. In operation, a user may select to initiate analysis of one or more attribution models via an application 110 (e.g., a marketing analytics application). For example, a user may indicate a desire to identify a “best” or “most effective” attribution model(s) in attributing events to achieving a metric or goal. As another example, a user may select to rank attribution models in order of quality. In some cases, a user may specify a set of attribution models for which analysis is to be performed. In other cases, a set of attribution models may be automatically selected (e.g., all attribution models are selected by default). In embodiments, a user may indicate or specify a data set to be analyzed in association with the attribution model. For example, a user may specify a date range, a demographic, or the like, for which event paths are to be analyzed. Additionally or alternatively, default settings may be used to perform attribution model analysis (e.g., all event paths within the last month, etc.). Such a selection of attribution models and/or data set attributes may be obtained by the user device 102 via a graphical user interface. Based on the analysis of attribution models, the user device 102 can provide various information related to the attribution model analysis (e.g., via application 110). For example, lift scores and/or insights associated therewith can be presented to a user via the user device 102. Lift scores and/or corresponding insights can be presented in any manner, and the analysis details and/or manner in which they are presented are not intended to be limiting to the examples provided herein.

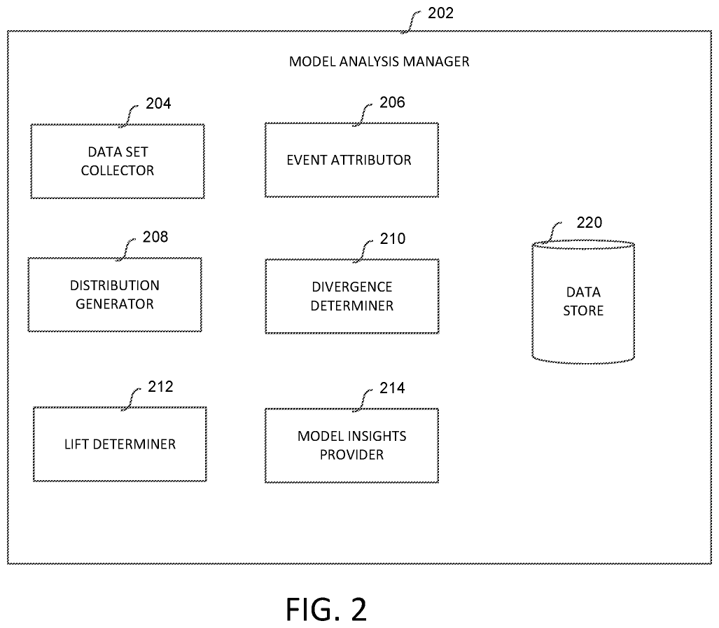

As described herein, server 108 can facilitate analysis of attribution models via model analysis manager 114. Server 108 includes one or more processors, and one or more computer-readable media. The computer-readable media includes computer-readable instructions executable by the one or more processors. The instructions may optionally implement one or more components of model analysis manager 114, described in additional detail below with respect model analysis manager 202 of FIG. 2. At a high level, model analysis manager 114 analyzes various attribution models to identify which of the attribution models performs most accurately or optimal in relation to identifying attribution of events, for example, to successful or favorable outcomes (e.g., marketing outcome such as a conversion). For example, as shown in FIG. 1, various models 120 may be options to utilize for determining attributions of events. As such, the model analysis manager 114 may be used to determine which of the candidate models, model 1, model 2, and model 3, provides a more effective attribution of the events. Generally, a good scoring attribution should highlight differences in positive (e.g., conversion) and negative (e.g., non-conversion) paths. In this way, a good score model should emphasize events, or touchpoints, more commonly appearing on positive paths (e.g., conversion paths) by assigning more credit to them. In this illustration of FIG. 1, model 3 may be identified as an effective attribution scoring model as it assigns high credit to events associated with conversions, whereas model 2 may be identified as less effective as it assigns high credit to events that do not correspond with conversions.

For cloud-based implementations, the instructions on server 108 may implement one or more components of model analysis manager 114, and an application residing on user device 102 may be utilized by a user to interface with the functionality implemented on server(s) 108. In other cases, server 108 may not be required. For example, the components of model analysis manager 114 may be implemented completely on a user device, such as user device 102. In this case, model analysis manager 114 may be embodied at least partially by the instructions corresponding to an application operating on the user device 102.

Thus, it should be appreciated that model analysis manager 114 may be provided via multiple devices arranged in a distributed environment that collectively provide the functionality described herein. Additionally, other components not shown may also be included within the distributed environment. In addition, or instead, model analysis manager 114 can be integrated, at least partially, into a user device, such as user device 102, and/or client device, such as client device 106. Furthermore, model analysis manager 114 may at least partially be embodied as a cloud computing service.

Referring to FIG. 2, aspects of an illustrative model analysis management system are shown, in accordance with various embodiments of the present disclosure. At a high level, a model analysis manager 202 can manage analysis of a set of attribution models. In this regard, the model analysis manager 202 can analyze various attribution models to identify effectiveness of the attribution models, for example, in association with a metric and/or set of event paths. For example, the model analysis manager 202 can analyze various attribution models to identify which of attribution model(s) performs most accurately or optimal in relation to identifying attribution of events to successful or favourable outcomes (e.g., marketing outcome such as a conversion).

Generally, there are multiple events or touch points, such as ad presentations and user selections/navigations, occurring before a conversion is actually performed. Because of the multiple events leading up to a conversion, it is oftentimes desirable to attribute revenue that is appropriate to each of these events or touch points, as appropriate, to designate an event or set of events as contributing to the conversion. As such, determining attribution provides an indication of an event(s) that influences individuals to engage in a particular behavior, resulting in a revenue gain or conversion. Accordingly, generally, attribution is used to quantify the influence an event(s) has on a consumer's decision to make a purchase decision, or convert. By attributing revenue to an event(s), historical revenue data and patterns can be identified and used to allocate advertising budget.

By way of example only, assume that several events precede a conversion including a first event of an advertisement being displayed on first page, a second event of a user clicking on one or more of advertisements, and a third event of a related posting on a social networking website. Based on a particular attribution model, one or more of the events can be selected for attributing the revenue associated with the conversion. To this end, the conversion revenue can be attributed to the advertisement display, the advertisement selection, and/or the social network posting depending on the model employed. Upon attributing revenue to one or more events, such data can be used to determine an allocation on an allotted budget, as described in more detail herein. Although this example refers to revenue associated with a conversion, as can be appreciated, conversions do not need to relate or correspond to revenue. For instance, a conversion may include a website visit, which does not necessarily result in revenue.

As described herein, an attribution model refers to a model that determines or identifies attribution, or a portion of credit, to events of an event path. Such an event path can correspond with an outcome or goal, such as a successful marketing outcome (e.g., a conversion). In this regard, in accordance with identifying an event or set of events (or touch points) that contribute to a desired outcome (e.g., a conversion), the attribution model can be used to assign an attribution value to such events. Attribution generally refers to a portion of credit for an event(s) resulting in a particular outcome (e.g., a conversion, such as a purchase or order placed via a website). In embodiments, the particular outcome relates to revenue or conversions. A conversion generally refers to an action taken or completed by an individual or client, such as an action achieving a marketing goal (e.g., user purchases an item for sale, completes and submits a form, etc.). In this way, an attribution model can be a model (e.g., rules, algorithm, etc.), that determine how revenue is assigned to touch points or events in an event path (e.g., a path to a conversion or revenue). Marketers may use attribution models to learn what combination of events are most effective at driving a customer or client to convert. The attribution results from the attribution models can be used to determine various information, such as return on investment (ROI) for marketing efforts, optimize marketing spend, and/or the like. As such, a marketer understanding attribution for various events enables the marketer to allocate spending to maximize return on investment.

As described, attribution models are used to assign credit to various events on an event path, for example, resulting in a conversion. An event path refers to a sequence of events or actions that are performed or engaged with in traversing a path to an outcome (e.g., a positive or successful outcome). An event or touch point refers to any event or point along an event path of achieving a conversion or other outcome (e.g., revenue means/goal). Generally, an event may be an interaction or action performed or detected via a computer (computer-based events). Events may be performed by, or engaged in, by a user (e.g., user selection or user viewing). Events may alternatively or additionally be performed via computing activity (e.g., initiated via a marketer), such as communicating an email. Examples of computer-based events include selecting or clicking on a particular product link, navigating to a particular website, a selection of a social network post, a viewing of a social network post or advertisement, performing a search, viewing a paid social post, viewing an email, and the like. As can be appreciated, in some cases, an activity can be a conversion in one model and an event in another. For instance, a free trial might be a touchpoint for a paid subscription, but one may also want to know what marketing activity deserves credit for getting individuals signed up for free trials.

Various attribution models may be used, for example, in the form of heuristics, rules, and/or algorithms. Examples of attribution models include single source attribution, fractional attribution, and algorithm or probabilistic attribution. A single source attribution generally refers to a model that assigns all credit to a single event, such as a last event (e.g., last click, last touch point, last ad presentation, etc.) or a first event (e.g., first click, first touch point, first ad presentation, etc.). A fractional attribution generally refers to a model that assigns equal or curved (e.g., U-curved) weights or credits to multiple events, such as equal attribution to each event or touch point in an event path. Algorithmic or probabilistic attribution uses automated computation and data-based modeling to determine and assign credit across touch points and events preceding the conversion. Specific examples of attribution models include a last interaction attribution model (e.g., all credit assigned to last event), a last non-direct click attribution model, a first interaction attribution model (e.g., all credit assigned to first event), a linear attribution model (e.g., credit is assigned equally to events), a u-shape attribution model (e.g., first and last events assigned a higher credit), a decay attribution model (e.g., credit decays exponentially with respect to time), a position-based attribution model, an influenced algorithmic attribution model, and a sourced algorithmic attribution model. The influenced and sourced algorithmic attribution models can learn relationships for various events to understand events that are most effective in obtaining a successful outcome (e.g., a conversion).

As shown in FIG. 2, model analysis manager 202 can include a data set collector 204, an event attributor 206, a distribution generator 208, a divergence determiner 210, a lift determiner 212, a model insights provider 214, and a data store 220. The foregoing components of model analysis manager 202 can be implemented, for example, in operating environment 100 of FIG. 1. In particular, those components may be integrated into any suitable combination of user device(s) 102, client device(s) 106, and/or server(s) 108.

Data store 220 can store computer instructions (e.g., software program instructions, routines, or services), data, and/or models (e.g., attribution models) used in embodiments described herein. In some implementations, data store 220 stores information or data received or generated via the various components of model analysis manager 202 and provides the various components with access to that information or data, as needed. Although depicted as a single component, data store 220 may be embodied as one or more data stores. Further, the information in data store 220 may be distributed in any suitable manner across one or more data stores for storage (which may be hosted externally).

In embodiments, data stored in data store 220 includes event data, distribution data, divergence data, lift data, and/or model insight data. Event data generally refers to data associated with an event path, or events associated therewith. As such, event data can include data pertaining to or related to an event path(s) and/or corresponding events. Event data may include interaction data indicating interactions with websites, applications, etc. In this regard, as data is accumulated in relation to client progress through an event path, the data can be stored in data store 212. The events associated with an event path may be stored in association with the event path. Event data may include, for example, a type of an event, a time associated with an event, a client associated with an event, an outcome associated with a set of events (e.g., an outcome of the event path, such as a conversion), and/or the like.

Distribution data generally refers to data associated with a distribution(s). Distribution data may be an array of data indicating various distributions. Distribution data may be stored in connection with unweighted and/or weighted distributions. As described herein, distribution data may correspond with various attribution models and various types of event paths (e.g., positive event paths, negative event paths, reference event paths, and/or scored event paths). Divergence data generally refers to data associated with divergences (e.g., divergence values). Lift data generally refers to any data associated with lifts (e.g., lift values).

Model analysis, via the model analysis manager 202, may be initiated or triggered in any number of ways. As one example, in some embodiments, a user (e.g., marketer) may select to view results or output (e.g., lift data) associated with a set of attribution models. By way of example only, a user may select a set of attribution models and input a selection to view analysis results associated with such attribution models. For instance, a marketer may wish to identify which of a set of models most effectively determines attribution. As described above, in some cases, a user may input or select a set of attribution models for which analysis is desired. In other cases, a set of attribution models may be automatically defined (e.g., each attribution model). In other embodiments, model analysis may be automatically triggered or initiated. For instance, upon initiating an application or selecting to view marketing analytics, model analysis may be automatically initiated (e.g. with a default set of attribution models).

The data set collector 204 is generally configured to receive or obtain a data set for use in performing attribution model analysis. The data set collector 204 can obtain a data set, which can include various event paths. Each event path may include event data associated with a set of events and an outcome of an event path. Event data may include an indication of an event type and an indication of an event date/time. In this regard, for each event in an event path, an event type and an event date may be obtained. An event type refers to a type of event. Event types may include, but are not limited to, an email, a paid social post, a search, etc. An event date may include an indication of a day and/or time corresponding with the event. In some cases, the event date may be an actual date and time. In other cases, the event date may be a relative date (e.g., a number of days prior to a conversion, etc.). An outcome of an event path may indicate whether an event path resulted in a positive outcome or a negative outcome. For example, an outcome may be positive in cases that a conversion is achieved, and an outcome may be negative in cases that a conversion is not identified as being achieved. Although positive and negative event paths are generally described herein in relation to conversion or no conversion, event paths may be related to other positive or negative path outcomes, such as other marketing or revenue aspects associated with a campaign, user engagement with a product, etc.

The data set collector 204 may obtain data sets (e.g., event data) from a data store, such as data store 220. In embodiments, the data store 220 may collect or obtain data from various components, for example, that may monitor for events. For example, a component, such as an event monitor operating on a client device (e.g., client device 106 of FIG. 1) or operating on a remote computing device (e.g., server) that communicates with the client device may monitor for various events and collect data accordingly. By monitoring client interactions (e.g., with websites, applications, etc.), an event monitor can listen for events, track events, and track paths taken by clients. In accordance with detecting events, an event monitor can record and/or report on such events. As described, such data can be initially collected at remote locations or systems and transmitted to data store 220 for access by data set collector 204.

For example, in some embodiments, event data may be obtained and collected at a client device via one or more sensors, which may be on or associated with one or more client devices and/or other computing devices. As used herein, a sensor may include a function, routine, component, or combination thereof for sensing, detecting, or otherwise obtaining information, such as event data, and may be embodied as hardware, software, or both. In addition or in the alternative to obtaining event data via client devices, such event data may be obtained from, for example, servers, data stores, or other components that collect event data, for example, from client devices. For example, in interacting with a client device, data or usage logs may be captured at various data sources or servers and, thereafter, such event data can be provided to the data store 220 and/or data set collector 204. Event data can be obtained at a remote source periodically or in an ongoing manner (or at any time) and provided to the data store 220 and/or data set collector 204 to facilitate analysis of attribution models.

The particular data set of event data obtained via data set collector 204 can be determined or identified in any number of ways. In some cases, a default set of event data may be obtained. For example, event data associated with event paths initiated or started in the last month may be obtained, or event paths terminated in the last month may be obtained. In other cases, a user (e.g., marketer) may provide an indication of desired event paths to use for the model analysis. For example, a user may select any number of parameters indicating an event path data set to obtain. For instance, a user may select a date range or time parameter (e.g., event data within a defined period of time), a client segment (e.g., client demographic, geography, device type, etc.), or the like. As such, the data set collector 204 may obtain a parameter(s), for example, from a user device operated by a user viewing the attribution model analysis data. Any data set parameters may be stored, for instance, at data store 220.

Based on a data set parameter(s), a set of event data can be obtained by the data set collector 204. In embodiments, the data set collector 204 can obtain event data that corresponds with a set of event paths. For example, the data set collector 204 may obtain event type and event date associated with a number of events of as well as an indication of an event outcome (e.g., positive event or negative event). As described, such event data can be accessed via data store 220, which may obtain data from any number of devices, including client devices and/or application servers. For example, a client device used by a client may capture event data in any number of ways, including utilization of sensors that capture information. As another example, a server (e.g., application server) in communication with a client device may gather log or usage data associated with usage of a client device, or portion thereof. Although described as accessing event data from data store 220, event data can alternatively or additionally be obtained from other components, such as, for example, directly from client devices or application servers in communication with client devices, another data store, or the like.

In some cases, the event data may be processed prior to being received at the data store 220. Additionally or alternatively, the data may be processed at the data store 220 or other component, such as data set collector 204 (e.g., to identify outcomes). In this regard, the data store 220 may store raw data and/or processed data. For example, data logs may be mined to identify dates or event types associated with various events. As one example, log data may be analyzed to identify a type of event and an event date associated with an interaction or touch point. As another example, log data may be analysed to identify an outcome associated with an event path. Such data can be stored in the data store (e.g., via an index or lookup system) for subsequent utilization by the data set collector 204.

As can be appreciated, the data set collector 204 can collect event data (e.g., via the data store 220) associated with positive and negative event paths. As described, a positive event path is an event path that results or ends in a positive or desired manner (e.g., successful), and a negative event path is an event path that results or ends in a negative or undesired manner (e.g., unsuccessful).

The event attributor 206 is generally configured to determine attributions for events associated with event paths (e.g., in the obtained data set). In this regard, the event attributor 206 can attribute or designate credit, revenue, and/or cost to an event(s) in an event path leading to an outcome. As such, an attribution, or attribution score/value, for an event can represent the attribution of the event to the corresponding outcome, such as a conversion. Accordingly, an attribution can be used to quantify the influence an event(s) has on a consumer's decision to make a purchase decision, or other conversion.

As described, attribution identifies and assigns a value to one or more of the events in an event path associated with an outcome. An event or touch point generally refers to any event or point along the path flow in association with an outcome, such as achieving a conversion or other revenue means. An event may be, for example, an advertisement displayed on a webpage, a click on an advertisement, a social network post, an email communication, etc. Generally, there are multiple touch points or events, such as advertisement presentations and user selections/navigations, occurring before a conversion is actually performed. As such, the event attributor 206 can identify attributions or attribution scores for any number of events to designate an event or set of events as contributing to the conversion.

The event attributor 206 may use any attribution model to generate and/or assign attributions to events. To this end, any type of attribution model can be used to perform or achieve this attribution, that is, attribute revenue or credit to an event(s). Examples of attribution models include single source attribution, fractional attribution, and algorithm or probabilistic attribution. For instance, attribution models may include a last interaction attribution model, a last non-direct click attribution model, a first interaction attribution model, a linear attribution model, a time decay attribution model, a position based attribution model, an algorithmic attribution model, and/or the like.

In accordance with embodiments described herein, the event attributor 206 determines attributions using multiple attribution models such that the attribution models can be analyzed in accordance with one another (e.g., to identify a more effective attribution model). A particular set of attribution models for use by the event attributor 206 can, in some embodiments, be selected by a user (e.g., a marketer). In this way, a marketer, or representative thereof, can select a set of attribution models from a set of potential attribution models based on the marketer's desired preferences for performing model analysis. In other embodiments, the event attributor 206 may determine attributions for a default or predetermined set of attribution models. For instance, each attribution model may be used to determine attributions for events in the data set. The available set of potential attribution models can be of any number and is not intended to limit the scope of embodiments of the present invention. Rather, the attribution models described herein are meant to be exemplary in nature.

In some embodiments, the event attributor 206 may determine attributions (using a set of attribution models) in association with positive event paths. In this regard, event paths identified as positive (e.g., resulting in a conversion) can be analysed using various attribution models. For example, assume a data set is obtained that includes 100,000 event paths, with 45,000 of the event paths resulting in conversions. Further assume that two attribution models are being analysed. In such a case, the event attributor 206 may determine attributions of events associated with the 45,000 paths resulting in conversions using a first attribution model and determine attributions of events associated with the 45,000 paths resulting in conversions using the second attribution model.

In analyzing an event path (e.g., a positive event path) using a particular attribution model, an attribution score or value may be determined for each event of the event path. As such, each event path (e.g., resulting in a conversion) can correspond with a set of attribution scores or values for each of the events in the path. As multiple attribution models can be analyzed, each event path can correspond with multiple sets of attributions scores for the path, with each attribution model being used to generate a set of attribution scores for the event path.

By way of example only, assume two attribution models are being analyzed for a first positive event path having Event 1, Event 2, and Event 3 and a second positive event path having Event 4, Event 5, and Event 6. In such a case, event attributor 206 can execute the first attribution model and the second attribution model in association with the first positive event path to obtain a first set of attributions and a second set of attributions that correspond with Event 1, Event 2, and Event 3, respectively. Event attributor 206 can also execute the first attribution model and the second attribution model in association with the second positive event path to obtain a first set of attributions and a second set of attributions that correspond with Event 4, Event 5, and Event 6, respectively.

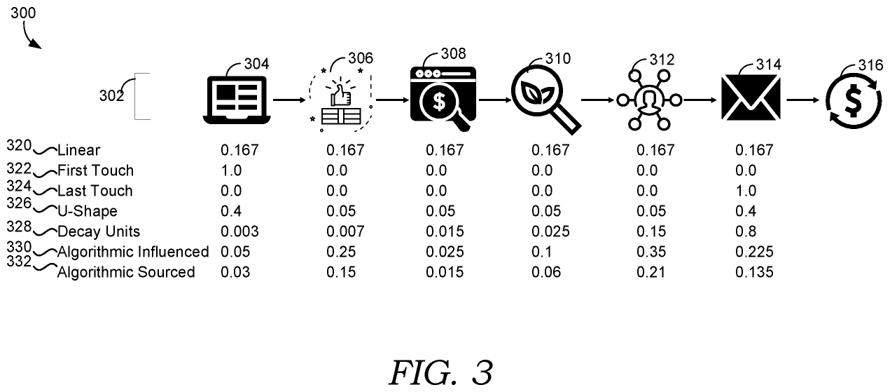

FIG. 3 provides an example 300 with regard to an event path 302. As illustrated, event path 302 includes event 304, event 306, event 308, event 310, event 312, and event 314 that result in an outcome 316 (e.g., conversion). The event attributor 206 can execute each of linear attribution model 320, first touch attribution model 322, last touch attribution model 324, u-shape attribution model 326, decay unit attribution model 328, influenced algorithmic attribution model 330, and sourced algorithmic attribution model 332. As shown, using each attribution model, a set of attributions are generated for each event of the event path 302. For example, for the sourced algorithmic attribution model 332, a 0.03 attribution score is determined for event 304, a 0.15 attribution score is determined for event 306, a 0.015 attribution score is determined for event 308, and so on. In this example using the sourced algorithmic attribution model 332, event 312 corresponds with the greatest attribution resulting in the conversion 316, while event 308 corresponds with the least attribution resulting in the conversion 316.

The distribution generator 208 is generally configured to generate path distributions associated with the various events, or event paths, in the data set. A path distribution generally refers to a distribution of values related to events in event paths. In this regard, a path distribution represents a number of event paths having a particular type of event at a particular time. Stated differently, a path distribution represents the values of lagged events and how frequently those lagged events occur in event paths. A lagged event, as used herein, generally refers to a particular type of event occurring within a particular time frame (lagged time frame). As generally described herein, the particular time frame can be a number of days, or a day range, relative to a conversion date. By way of example only, a lagged event may include an email event occurring three days prior to a conversion.

In embodiments, a path distribution may utilize bins as opposed to individual values. Bins can be used to define a range of event values (e.g., lagged event values) as a bin. Accordingly, events associated with a particular event type and occurring within a particular time frame can be grouped together in one bin such that one event path value represents the bin of lagged events. In this regard, distributions are discretized by a time lag and an event type.

As can be appreciated, in some cases, bins are predetermined. For example, types of events and/or event time frames may be specified by a user or automatically determined. Indications of such predetermined bins may be stored in a data store such that the lagged event bins can be identified and used for generating histograms. In other cases, bins may be determined in accordance with analyzing the data set in real time. For instance, a data set may be analyzed and a component, such as distribution generator 208 may dynamically determine bins (e.g., event types and event time frames) based on the event data in the data set (e.g., types of events and appropriate date ranges). Other discretization schemes may also be used, and the examples provided herein are not intended to be limiting. Further, in some cases, a continuous distribution may be generated and used, for example, via a kernel density estimator. A particular form used for generating or representing distributions is not intended to be limited herein.

The distribution generator 208 may generate positive path distributions, negative path distributions, and reference path distributions. Generally, as described above, the path distributions represent the number of event paths corresponding with each lagged event bin (e.g., a particular event type occurring within a particular time frame). In this way, to generate a path distribution, a determination is made as to how many event paths have each particular type of lagged event.

A positive path distribution refers to a number of positive event paths corresponding with each lagged event. As such, to generate a positive path distribution, the distribution generator 208 can determine a number of positive event paths that correspond with each lagged event. To do so, the obtained data set can be accessed and used to identify positive event paths (e.g., event paths having a positive or successful outcome, such as a conversion). For the positive event paths, a count or determination is made of each event path that includes a particular lagged event, that is, a particular type of event corresponding with a particular time duration (e.g., relative to an outcome or conversion).

A negative path distribution refers to a number of negative event paths corresponding with each lagged event. As such, to generate a negative path distribution, the distribution generator 208 can determine a number of negative event paths that correspond with each lagged event. To do so, the obtained data set can be accessed and used to identify negative event paths (e.g., event paths having a negative or unsuccessful outcome, such as no conversion being achieved). For the negative event paths, a count or determination is made of each event path that includes a particular lagged event, that is, a particular type of event corresponding with a particular time duration (e.g., relative to an outcome or conversion).

A reference distribution generally refers to a distribution that reflects or represents the aggregated values related to measuring the deviation between positive and negative paths. In this way, a reference distribution captures the difference in positive and negative event paths. In some cases, a reference distribution incorporates a penalty for having too many events of a single type on a path. In this regard, a reference distribution may include the difference between the number of positive event paths and negative event paths corresponding with each lagged event divided by an average number of tokens. As used herein, a token can include a combination or aggregation of events. For example, in instances in which ten emails are sent in close proximity to one another, a token may represent the set of ten email events. Utilizing tokens can limit the amount of credit each event would otherwise obtain individually. In this way, tokens can provide an implicit penalty for marketers that spam users with too many of the same events. As such, to account for such a penalty, a reference distribution may be represented by:

R=max([nₚₚₜ−nₙₚₜ]/E(nₜₒₚ),0.0)

wherein ppt denotes positive event paths touched, npt denotes negative event paths touched, nₜₒₚ denotes the number of tokens per path, and E denotes the expected value (e.g., average). In this regard, to determine a reference distribution, a number of negative paths touched can be subtracted from the number of positive paths touched (e.g., for each lagged event bucket). This path number difference can then be divided by an estimate of the number of lagged event tokens per path. As described, a token generally refers to a set of events that occur within a particular time frame. As such, tokens per path can be used to reflect that marketing channels are penalized if used too frequently. In some cases, if the numbers of positive and negative paths are not equal (or approximately equal), the number of the positive and/or negative events can be scaled by a factor that would make the number of positive and negative event paths equal. The reference distribution described here is one embodiment of a reference distribution that may be used.

In accordance with embodiments described herein, the distribution generator 208 generates a weighted-positive path distribution. A weighted-positive path distribution refers to a positive path distribution that takes into account the attribution scores. As previously described, each event in the positive event paths has a corresponding attribution score for a particular attribution model. Such attribution scores corresponding with the events can be used as an attribution weight to weight each value or count for each bin of the distribution. In embodiments, the positive path distribution is computed by counting the unique appearances of lagged touchpoints on positive paths, and the weighted distribution includes summing the attribution scores for lagged touchpoints on positive paths.

As each attribution model includes different attribution scores for events, a weighted-positive path distribution can be generated for each attribution model being analyzed. For example, assume a first and second attribution models are being analyzed. In such a case, a first weighted-positive path distribution may be generated using attribution scores determined via the first attribution model, and a second weighted-positive path distribution may be generated using attribution scores determined via the second attribution model.

In embodiments, the positive distribution, the weighted-positive distributions, the negative distribution, and/or the reference distribution are normalized. In this regard, various probability distributions can be generated to indicate likelihood of events. To normalize distributions, or generate probability distributions, the total number or count of event paths, sum of scored events, and/or reference value (i.e., the value of R for a particular bin) falling within all the bins can be determined and used to normalize the data. For example, assume a first bin includes a count of 10 event paths, a second bin includes a count of 20 event paths, and a third bin includes a count of 5 event paths. In such a case, a total of 35 events can be determined. Each event path count per bin can then be divided by this determined total number (e.g., 35) to normalize the distribution.

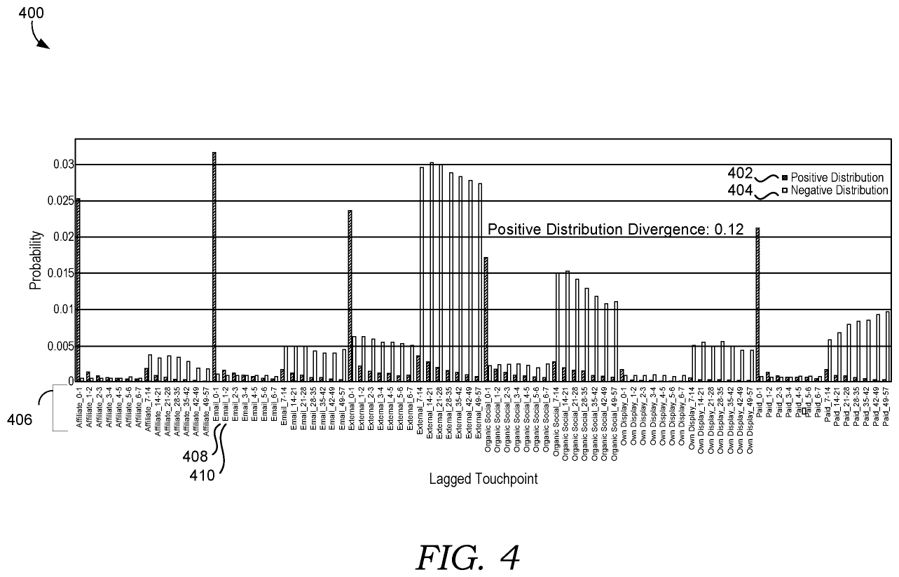

By way of example only, and with reference to FIG. 4, FIG. 4 illustrates a representation 400 of a positive probability distribution 402 and a negative probability distribution 404. As shown, a set of bins 406 are positioned along the x-axis. Each bin represents a particular type of event and a corresponding time frame, as measured from an outcome (e.g., a conversion date or no-conversion date). For example, bin 408 represents an email event type occurring 0-1 days before an outcome date, and bin 410 represents an email event type occurring 1-2 days before an outcome date.

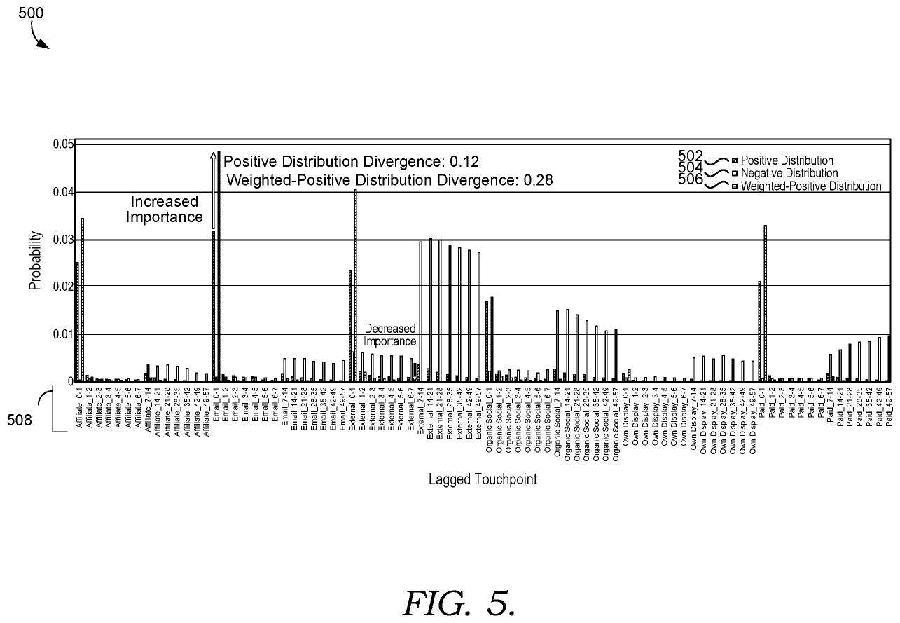

FIG. 5 illustrates a representation 500 of a positive probability distribution 502, a negative probability distribution 504, and a weighted-positive probability distribution 506. As shown, a set of bins 508 are positioned along the x-axis. Each bin represents a particular type of event and a corresponding time frame, as measured from an outcome (e.g., a conversion date or no-conversion date). Generally, the weighted-positive probability distribution should reflect a greater or higher dissimilarity to the negative probability distribution. In this regard, weighting the positive probability distribution using attribution scores provides more credit to the aspect of the positive path distribution that is higher than the negative path distribution and reduce credit to the aspect that is less than or equal to the negative path distribution.

Although FIG. 4 and FIG. 5 do not include a reference probability distribution, such a reference probability distribution may be represented in a similar manner. Further, although visually represented via a graph in FIG. 4 and FIG. 5, distributions can be represented in any manner. For example, distributions can be represented and stored as numerical data, such as, for example, an array of numbers. Accordingly, a graphical representation need not be generated, but is provided herein for illustrative purposes.

The divergence determiner 210 is generally configured to determine divergence between distributions. Generally, a divergence indicates a measure or extent of dissimilarity (or similarity) between distributions. Any number of divergence methods can be used to compare two probability distributions. Examples of divergence methods that may be used in accordance with embodiments described herein include, for example, Jensen-Shannon (JS) divergence, Kullback-Leibler (KL) divergence, etc.

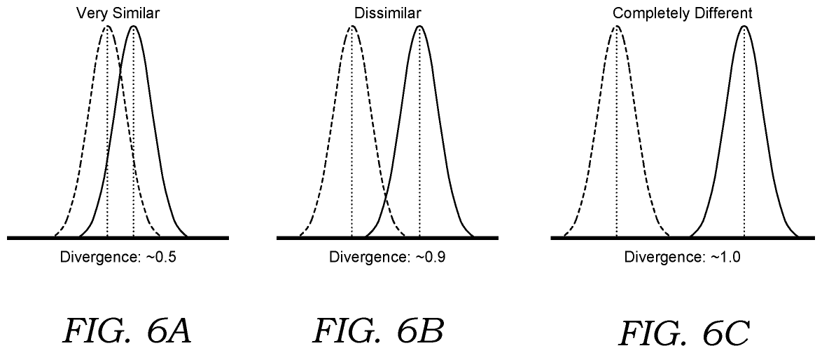

FIGS. 6A-6C illustrates examples of various divergences between two distributions and corresponding extent of dissimilarity. In FIG. 6A, the divergence is approximately 0.5. In such a case, the distributions can be considered very similar. With reference to FIG. 6B, the divergence shown is approximately 0.9. In this example, the distributions can be considered dissimilar. In FIG. 6C, the divergence is approximately 1.0. In such a case, the distributions can be considered completely different.

In some embodiments, the divergence determiner 210 uses Jensen-Shannon (JS) divergence to determine divergence between distributions. As described, JS divergence quantifies the difference, or similarity, between two probability distributions. In particular, JS divergence is a symmetrical, smoothed version of the KL divergence and bounded by 0.0 and 1.0. An example equation for determining JS divergence between a weighted-positive path distribution (W) and a reference path distribution (R) can be represented as:

JS(W∥R=½Σₓ(W(x)*log(W(x)/M(x))+R(x)*log(R(x)/M(x))), where M=½(W+R)

In this example equation, the JS divergence between the weighted-positive path distribution W and the reference path distribution R is one-half the sum of weighted values associated with each of the bins in the weighted-positive path distribution and weighted values of each of the bins in the reference path distribution. As shown, the weighted values associated with each of the bins in the weighted-positive path distribution are the values associated with each of the bins in the weighted-positive path distribution times a weight, which in this case is the log of the corresponding value over the M (i.e., 0.5*(W+R)). Similarly, the weighted values associated with each of the bins in the reference path distribution are the values associated with each of the bins in the reference path distribution times a weight, which in this case is the log of the corresponding value over M (i.e., 0.5*(W+R)). Such JS divergence may similarly be used to compare other path distributions, such as, for example, the weighted-positive path distribution to the negative path distribution.

In some embodiments, an enhanced or modified JS divergence may be used to compare path distributions. In this regard, the JS divergence can be modified to reward divergence in a correct direction or, stated differently, to penalize certain types of deviations. For example, when comparing a weighted-positive path distribution (W) to a negative path distribution (N), a higher divergence is a good if, and only if, there is not a sign change relative to the negative path distribution (N) and the positive path distribution (P). As such, a modified JS divergence that factors in a sign indicator or sign correction term (positive or negative sign) is valuable to reward divergence in a correct direction. At a high level, the sign correction term uses the positive path distribution (P) to determine if a penalty is applied. An example equation for determining JS modified (JSM) divergence between a weighted-positive path distribution (W) and a negative path distribution (N) can be represented as:

$$JS ( W ‖ N , P ) = \frac{1}{2} {\sum }_{x} ( W ( x ) * log ( \frac{W ( x )}{M ( x )} ) + N ( x ) * log ( \frac{N ( x )}{M ( x )} ) ) * sign ( ( W ( x ) - N ( x ) ) * ( P ( x ) - N ( x ) ) ) , where M = \frac{1}{2} ( W + N ) \qquad$$

As can be appreciated, such a JS modified divergence provides a negative divergence if either of these conditions exist:

W>N but P<N

W<N but P>N

To this end, if the weighted-positive path distribution is less than the negative path distribution but the positive path distribution is greater than the negative path distribution, or if the weighted-positive path distribution is greater than the negative path distribution but the positive path distribution is less than the negative path distribution, the JS modified divergence applies a penalty (e.g., the sign is inverted to negative). Such JSM divergence may similarly be used to compare other path distributions.

As described herein, in some embodiments, JS divergence is used to determine divergence between the weighted-positive path distribution and the reference path distribution, while JSM divergence is used to determine divergence between the weighted-positive path distribution and the negative path distribution. As can be appreciated, JS divergence indicates distribution changes, but does not take into account the impact of the change. As such, JS divergence is effective in comparing the weighted-positive path distributions to reference path distributions because deviation from the reference path distribution in any direction is considered similarly poor. When comparing the weighted-positive path distributions to negative path distributions, however, deviation in any direction is not considered similarly poor.

In operation, the divergence determiner 210 can determine divergence between the weighted-positive path distribution and the reference path distribution and divergence between the weighted-positive path distribution and the negative path distribution for each attribution model being analyzed. For example, assume a first and second attribution model are being analyzed and, as such, both the first and second attribution models are used to generate corresponding attribution scores for use in determining corresponding weighted-positive path distributions. The first weighted-positive path distribution, generated in accordance with attribution scores determined via the first attribution model, can be compared to the reference path distribution and the negative path distribution to generate a first and second divergence, respectively. Similarly, the second weighted-positive path distribution, generated in accordance with attribution scores determined via the second attribution model, can be compared to the reference path distribution and the negative path distribution to generate a third and fourth divergence, respectively.

The lift determiner 212 is generally configured to determine lift for attribution models being analyzed. Lift or a lift value, as used herein, generally refers to a measure of the performance of a particular attribution model measured against a baseline attribution model. As such, the lift determiner 212 can transform divergences into a lift measurement to compare the relative improvement of each model versus some reference model. A baseline attribution model may be any attribution model that is used as a baseline or reference for determining lift. For example, a baseline attribution model may be a linear attribution model, a first touch attribution model, or the like. A baseline attribution model may be any of the available models, and may be automatically selected (e.g., as a default) or selected by a user (e.g., a marketer).

At a high level, various divergences (e.g., divergences determined via divergence determiner 210) are used to determine a lift score. One example equation for determining lift can be represented as follows:

$$Lift = \frac{JSM ( W ‖ N , P )}{JSM ( B ‖ N , P )} + \frac{JS ( B ‖ R )}{JS ( W ‖ R )} - 1$$

The W denotes the weighted-positive path distribution associated with the attribution model for which the lift is being determined, the N denotes the negative path distribution, the P denotes the positive path distribution, the R denotes the reference path distribution, and the B denotes the baseline model weighted-positive path distribution (the weighted-positive path distribution associated with a baseline model). In this equation, the first term, namely the JSM divergence between the weighted-positive path distribution and negative path distribution relative to the JSM divergence between the baseline path distribution and negative path distribution, measures to what extent a particular attribution model assigns credit to events that infrequently appear on negative paths. In this regard, this term measures how effectively one model concentrates credit in areas that are not frequently on negative paths. For example, one model could put 100% of credit in an area where there is a very low negative distribution density.

The second term, namely the JS divergence between the baseline path distribution and reference path distribution relative to the JS divergence between the weighted-positive path distribution and reference path distribution, measures an extent or degree to which the particular attribution model reflects the positive, negative path difference. This second term generally represents a correction factor that reflects that not all deviations from the negative path distribution are equal, and the lift values should be proportional to the positive and negative path difference. The corrector factor effectuates an “extra credit” when the divergence from the reference distribution is lower as compared to the base model. Such “extra credit” can be proportional to the baseline model divergence from the negative distribution. While the portion of the lift coming from the divergence from the reference distribution is presented as a correction factor to the portion coming from the divergence from the negative distribution, the reverse relationship is also true. The portion of the lift coming from the divergence from the negative distribution is also a corrector to the portion coming from the divergence from the reference distribution.

The lift determiner 212 may determine lift values for each attribution model being analyzed relative to a particular baseline model. As can be appreciated, a lift value determined for a baseline attribution model will be one. Generally, the greater the lift value for an attribution model, the more effective the attribution model or the better relative performance of the attribution model. Advantageously, the lift value or lift score provides results that can indicate a percent improvement versus a baseline, which has intuitive meaning for users, such as marketers. Further, embodiments described herein enable attribution models to be compared across multiple applications and enable assessment of the impact of attribution model changes during development.

The model insights provider 214 provides model insights. In this regard, the model insights provider 214 may provide model insights to a user device, such as a user device operated by a marketer. In some embodiments, model insights may include lift values associated with attribution models being analyzed. For example, assume four attribution models are being analyzed. In such a case, a lift score is determined for each attribution model. A listing of each attribution and corresponding lift scores can then be provided to a user device. In some cases, a greatest or highest lift value(s) may be presented (e.g., a predetermined number of the greatest lift values). In other cases lift values exceeding a threshold value may be presented.

In embodiments, model insights may additionally or alternatively include data used to generate the lift values. For example, distribution representations, divergences, and/or the like may be presented in connection with a corresponding lift value. Model insights may also include suggestions, recommendations, or other data derived related to a particular attribution model in accordance with the lift score for the particular attribution model. In some cases, model insights (e.g., lift values) may be used to select an attribution model, for example, for use in another application (e.g., budget optimization). For instance, an attribution model with a highest lift score may be selected by a user, or automatically selected, for use in performing budget optimization.

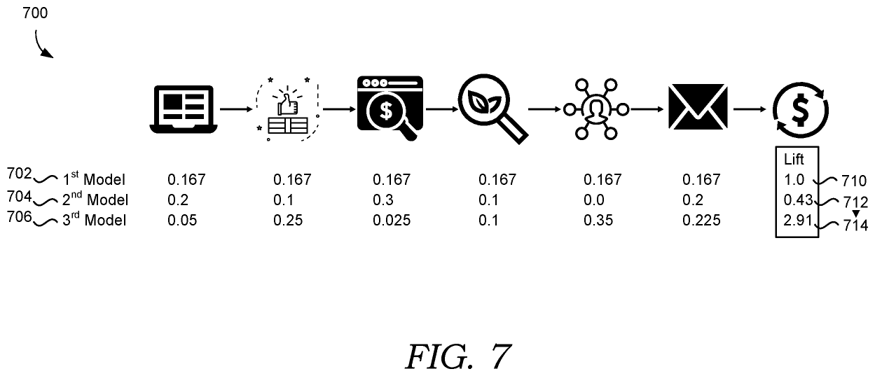

As one example, and with reference to FIG. 7, FIG. 7 provides one example 700 of a model insights that may be provided to a user, such as a marketer, via a graphical user interface. As shown in FIG. 7, a first attribution model 702, a second attribution model 704, and a third attribution model 706 are presented. As shown, the corresponding lift values for each of the attribution models are also provided. For example, the lift value 710 for the first attribution model is 1.0, indicating the first attribution model is the baseline model). The lift value 712 for the second attribution model is 0.43, indicating a lower performing attribution model. The lift value 714 for the third attribution model is 2.91, indicating a higher performing attribution model. Also shown in FIG. 7 are the various attribution scores for various events generated via the corresponding attribution model.

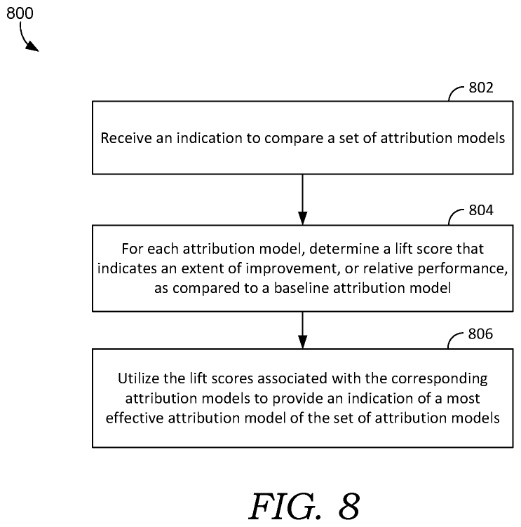

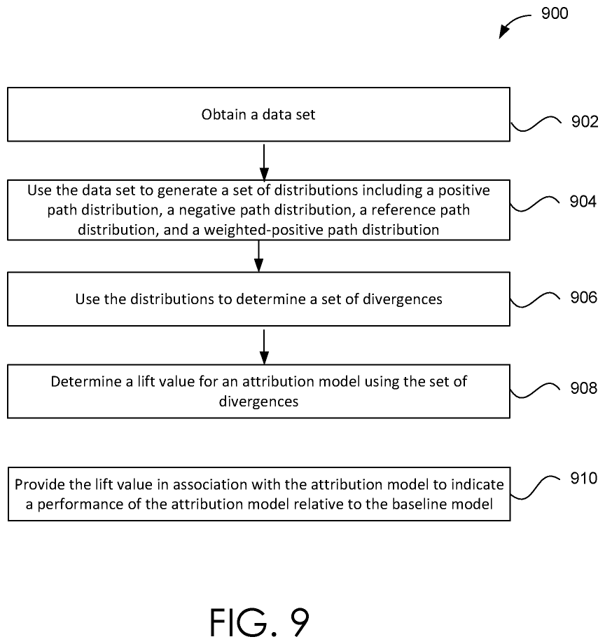

With reference now to FIGS. 8-9, FIGS. 8-9 provide method flows related to facilitating analysis of attribution models, in accordance with embodiments of the present technology. Each block of method 800 and 900 comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. The method flows of FIGS. 8-9 are exemplary only and not intended to be limiting. As can be appreciated, in some embodiments, method flows 800-900 may be implemented, at least in part, in real time to enable real time data to be provided to a user.

Turning initially to FIG. 8, a flow diagram 800 is provided showing an embodiment of a method 800 for facilitating analysis of attribution models, in accordance with embodiments described herein. Initially, at block 802, an indication to compare a set of attribution models is received. For example, via a graphical user interface, a user may select a desire to compare attribution models or provide a most effective or “best” attribution model. At block 804, for each attribution model, determining a lift score that indicates an extent of improvement, or relative performance, as compared to a baseline attribution model. In embodiments, the lift score is generated based at least on a first divergence between a weighted-positive path distribution and a negative path distribution determined using a sign correction term; a second divergence between the weighted-positive path distribution and the reference path distribution; and/or additional divergences, such as a single divergence combining both the first and second divergence previously described, or multiple additional divergences designed to reflect the deviation between positive in negative paths in non-redundant ways. The weighted-positive path distribution reflects attribution scores, generated via the corresponding attribution model, applied as weights to the positive event paths and used to produce a distribution. The positive path distribution can include a distribution related to event paths associated with conversions and the negative path distribution can include a distribution related to event paths associated with non-conversions. A reference path distribution can indicate the difference between the positive path distribution and the negative path distribution.

At block 806, the lift scores associated with the corresponding attribution models are used to provide an indication of a most effective attribution model of the set of attribution models. For example, the most effective attribution model may most effectively distinguish differences in positive event paths (e.g., conversions) and negative event paths (non-conversions). As another example, the most effective attribution model most effectively distinguishes events more commonly appearing on conversion event paths by assigning the events more credit. In some cases, the most effective attribution model is automatically selected for use in performing budget optimization. The lift scores may be presented in association with corresponding attribution models via a graphical user interface.

Turning to FIG. 9, a process flow is provided showing an embodiment of a method 900 for facilitating analysis of attribution models, in accordance with embodiments described herein. At block 902, a data set is obtained. The data set includes a set of event paths associated with outcomes (e.g., positive conversion outcome or negative non-conversion outcome). At block 904, the data set is used to generate a set of distributions including a positive path distribution, a negative path distribution, a reference path distribution, and a weighted-positive path distribution. The positive path can include a number of positive event paths (e.g., conversions) corresponding with each lagged event of a set of lagged events. The negative path distribution can include a number of negative event paths (e.g. non-conversions) corresponding with each of the lagged events. The reference path distribution indicates the difference between the positive path distribution and the negative path distribution. The weighted-positive path distribution reflects attribution scores, generated via an attribution model, applied as weights to the positive event paths and used to produce a distribution.

At block 906, the distributions are used to determine a set of divergences, including a first divergence, a second divergence, a third divergence, and a fourth divergence. The first divergence includes a divergence between the weighted-positive path distribution associated with the attribution model and the negative path distribution. Such a first divergence can use a sign correction term to account for any needed changes in the sign of the divergence. The second divergence includes a divergence between the weighted-positive path distribution and the reference path distribution. The third divergence is a divergence between a baseline weighted-positive path distribution associated with a baseline model and the negative path distribution. The baseline weighted-positive path distribution can be generated using baseline model attribution scores generated via the baseline model. The fourth divergence is a divergence between the baseline-weighted positive path distribution and the reference path distribution. Other divergences may be present in other embodiments.

At block 908, a lift value is determined for an attribution model using the first divergence, second divergence, third divergence, and fourth divergence. In particular, a lift value can be determined using the first divergence relative to third divergence and using the forth divergence relative to the second divergence. Other divergences may be used to compute the lift in other embodiments. At block 910, the lift value is provided in association with the attribution model to indicate a performance of the attribution model relative to the baseline model. As can be appreciated, lift values can be similarly generated for other attribution models. Such lift values can be used to compare performance of the various attribution models.

Having described embodiments of the present invention, FIG. 10 provides an example of a computing device in which embodiments of the present invention may be employed. Computing device 1000 includes bus 1010 that directly or indirectly couples the following devices: memory 1012, one or more processors 1014, one or more presentation components 1016, input/output (I/O) ports 1018, input/output components 1020, and illustrative power supply 1022. Bus 1010 represents what may be one or more busses (such as an address bus, data bus, or combination thereof). Although the various blocks of FIG. 10 are shown with lines for the sake of clarity, in reality, delineating various components is not so clear, and metaphorically, the lines would more accurately be gray and fuzzy. For example, one may consider a presentation component such as a display device to be an I/O component. Also, processors have memory. The inventors recognize that such is the nature of the art and reiterate that the diagram of FIG. 10 is merely illustrative of an exemplary computing device that can be used in connection with one or more embodiments of the present invention. Distinction is not made between such categories as “workstation,” “server,” “laptop,” “handheld device,” etc., as all are contemplated within the scope of FIG. 10 and reference to “computing device.”

Computing device 1000 typically includes a variety of computer-readable media. Computer-readable media can be any available media that can be accessed by computing device 1000 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by computing device 1000. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. Combinations of any of the above should also be included within the scope of computer-readable media.

Memory 1012 includes computer storage media in the form of volatile and/or nonvolatile memory. As depicted, memory 1012 includes instructions 1024. Instructions 1024, when executed by processor(s) 1014 are configured to cause the computing device to perform any of the operations described herein, in reference to the above discussed figures, or to implement any program modules described herein. The memory may be removable, non-removable, or a combination thereof. Exemplary hardware devices include solid-state memory, hard drives, optical-disc drives, etc. Computing device 1000 includes one or more processors that read data from various entities such as memory 1012 or I/O components 1020. Presentation component(s) 1016 present data indications to a user or other device. Exemplary presentation components include a display device, speaker, printing component, vibrating component, etc.

I/O ports 1018 allow computing device 1000 to be logically coupled to other devices including I/O components 1020, some of which may be built in. Illustrative components include a microphone, joystick, game pad, satellite dish, scanner, printer, wireless device, etc. I/O components 1020 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on computing device 1000. Computing device 1000 may be equipped with depth cameras, such as stereoscopic camera systems, infrared camera systems, RGB camera systems, and combinations of these, for gesture detection and recognition. Additionally, computing device 1000 may be equipped with accelerometers or gyroscopes that enable detection of motion. The output of the accelerometers or gyroscopes may be provided to the display of computing device 1000 to render immersive augmented reality or virtual reality.

Embodiments presented herein have been described in relation to particular embodiments which are intended in all respects to be illustrative rather than restrictive. Alternative embodiments will become apparent to those of ordinary skill in the art to which the present disclosure pertains without departing from its scope.

Various aspects of the illustrative embodiments have been described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features have been omitted or simplified in order not to obscure the illustrative embodiments.

Various operations have been described as multiple discrete operations, in turn, in a manner that is most helpful in understanding the illustrative embodiments; however, the order of description should not be construed as to imply that these operations are necessarily order dependent. In particular, these operations need not be performed in the order of presentation. Further, descriptions of operations as separate operations should not be construed as requiring that the operations be necessarily performed independently and/or by separate entities. Descriptions of entities and/or modules as separate modules should likewise not be construed as requiring that the modules be separate and/or perform separate operations. In various embodiments, illustrated and/or described operations, entities, data, and/or modules may be merged, broken into further sub-parts, and/or omitted.

The phrase “in one embodiment” or “in an embodiment” is used repeatedly. The phrase generally does not refer to the same embodiment; however, it may. The terms “comprising,” “having,” and “including” are synonymous, unless the context dictates otherwise. The phrase “A/B” means “A or B.” The phrase “A and/or B” means “(A), (B), or (A and B).” The phrase “at least one of A, B and C” means “(A), (B), (C), (A and B), (A and C), (B and C) or (A, B and C).”

What is claimed is:

1. A computer-implemented method for analyzing attribution models, the method comprising:
generating a set of distributions including at least one of a positive path distribution, a negative path distribution, and a reference path distribution that indicates the deviation between the positive path distribution and the negative path distribution as well as a weighted-positive path distribution that reflects attribution scores, generated via an attribution model, applied as weights to positive event paths;
determining a first divergence between two of the distributions of the set of distributions, the first divergence indicating an extent of the attribution model capturing a deviation between the positive event paths and negative event paths; and
determining a lift value for the attribution model using the first divergence between the two of the distributions of the set of distributions and a divergence associated with a baseline model.

2. The computer-implemented method of claim 1 further comprising:
obtaining a set of data including event paths associated with outcomes; and
using the set of data to generate the set of distributions.

3. The computer-implemented method of claim 1, wherein the positive path distribution includes a number of the positive event paths corresponding with each lagged event of a set of lagged events, and the negative path distribution includes a number of the negative event paths corresponding with each of the lagged events.

4. The computer-implemented method of claim 3, wherein the positive event paths correspond with conversions and the negative event paths correspond with non-conversions.

5. The computer-implemented method of claim 1, wherein the first divergence comprises a divergence between the weighted-positive path distribution associated with the attribution model and one of the negative path distribution or the reference path distribution.

6. The computer-implemented method of claim 5 further comprising:
determining a second divergence between the weighted-positive path distribution and either of the negative path distribution or the reference path distribution not used to determine the first divergence, wherein when the first divergence or the second divergence is determined using the negative path distribution, using a sign correction term.

7. The computer-implemented method of claim 6, wherein determining the lift value for the attribution model comprises determining the lift value using the first divergence relative to a divergence between a baseline weighted-positive path distribution associated with the baseline model and the negative path distribution and using a divergence between the baseline weighted-positive path distribution and the reference path distribution relative to the second divergence.

8. The computer-implemented method of claim 7 further comprising:
determining the divergence between the baseline weighted-positive path distribution and the negative path distribution; and
determining the divergence between the baseline weighted-positive path distribution and the reference path distribution.

9. The computer-implemented method of claim 7, further comprising:
identifying the baseline model; and
using the baseline model to generate baseline model attribution scores for weighting the positive path distribution to generate the baseline weighted-positive path distribution.

10. One or more computer-readable media having a plurality of executable instructions embodied thereon, which, when executed by one or more processors, cause the one or more processors to perform a method comprising:
receiving an indication to compare a set of attribution models;
for each attribution model of the set of attribution models, determining a lift score that indicates an extent of improvement as compared to a baseline attribution model, the lift score being generated based at least on a first divergence between a weighted-positive path distribution and one of a negative path distribution or a reference path distribution, the divergence determined using a sign correction term, wherein the weighted-positive path distribution reflects attribution scores, generated via the corresponding attribution model, applied as weights to positive event paths; and
using the lift scores associated with the corresponding attribution models to provide an indication of a most effective attribution model of the set of attribution models.

11. The media of claim 10, wherein the most effective attribution model most effectively distinguishes differences in the positive event paths and negative event paths.

12. The media of claim 10, wherein the most effective attribution model most effectively distinguishes events more commonly appearing on conversion event paths by assigning the events more credit.

13. The media of claim 10, wherein the most effective attribution model is automatically selected for use in performing budget optimization.

14. The media of claim 10, wherein the indication to compare the set of attribution models is provided via a user interface.

15. The media of claim 10, wherein the lift scores are presented in association with corresponding attribution models via a user interface.

16. The media of claim 10, wherein the positive path distribution comprises a distribution related to the positive event paths associated with conversions and the negative path distribution comprises a distribution related to negative event paths associated with non-conversions.

17. The media of claim 10, wherein the lift score being further generated based on a second divergence between the weighted-positive path distribution and either of the reference path distribution or the negative path distribution not used to determine the first divergence, the reference path distribution indicating the difference between the positive path distribution and the negative path distribution.

18. A computing system comprising:
means for determining a first divergence between two distributions associated with numbers of event paths; and
means for determining a lift value for the attribution model using the first divergence, the lift value indicating an extent of improvement as compared to a baseline attribution model.

19. The system of claim 18, wherein the first divergence comprises a divergence between a weighted-positive path distribution associated with the attribution model and a negative path distribution and further determining a second divergence between the weighted-positive path distribution and a reference path distribution.

20. The system of claim 19, wherein the lift value is determined using the first divergence relative to a divergence between a baseline-weighted positive distribution associated with the baseline attribution model and the negative path distribution and using a divergence between the baseline-weighted positive path distribution and the reference path distribution relative to the second divergence.
